(19) United States
(12) Patent Application Publication
(10) Pub. No.: US 2012/0199134 A1
(43) Pub. Date: Aug. 9, 2012

(54) HEEL OFFLOADING APPARATUS

(76) Inventor: Dawn Carson, Dresher, PA (US)

(21) Appl. No.: 13/368,003

(22) Filed: Feb. 7, 2012

Related U.S. Application Data
(60) Provisional application No. 61/440,229, filed on Feb. 7, 2011.

(51) Int. Cl. A61G 15/00

(52) U.S. Cl. 128/845

(57) ABSTRACT

A heel offloading apparatus including a cushion sized and adapted to surround at least a dorsal side of an Achilles tendon and substantially independently supports and stabilizes an ankle. The apparatus further includes a body for positioning the cushion relative to the ankle. The apparatus is configured to elevate an intended wearer's ankle and heel when the intended wearer is wearing the apparatus and lying in a supine position so as to relieve pressure from the heel and thereby prevent formation of heel pressure ulcers.

This application is a non-provisional of and claims benefit of priority to U.S. Provisional Application No. 61/440,229, filed Feb. 7, 2011, the entire disclosure of which is hereby incorporated by reference as if set forth fully herein.

### BACKGROUND OF THE INVENTION

1. Field of the Invention

The present invention is directed to an improved heel offloading device for patients that are immobile for periods of time, such as bedridden patients or patients immobilized due to surgery. In general, the present invention is related to devices for supporting and protecting the heel of a patient.

2. Description of the Related Technology

Well over ten million people in the U.S. suffer from conditions that cause immobility. These patients are confined in beds, and often limited to a supine position for extended periods of time, which may lead to a variety of complications. For example, immobile patients are susceptible to heel pressure ulcers, foot drop caused by the relaxation or weakening of the muscles controlling the foot, and heel cord contracture. In particular, pressure resulting from the load bearing contact between a patient's heel and an underlying support surface is a significant source of discomfort that often causes the formation of pressure ulcers. Because heels have a small surface area and a large underlying bony surface, they are particularly vulnerable to the formation of pressure ulcers.

Various devices have been proposed to address these problems, notable examples of which are described in U.S. Pat. Nos. 7,458,948, 4,186,738 and 5,449,339. These patents describe bulky heel-supporting boots that brace the patient's foot and leg, thereby restricting the normal range of motion of a patient's foot. Because such large, cumbersome boots are uncomfortable and can cause perfuse sweating of the legs and feet, there is a significant lack of patient compliance when such devices are prescribed. Furthermore, these boots do not securely retain a patient's foot, allowing the foot slide within and reorient itself relative to the boot. Such boots, therefore, may be unable to maintain a foot in an orientation that effectively offloads pressure on a patient's heel

In view of these deficiencies, there is a need to develop an improved heel offloading apparatus capable of effectively offloading pressure on a patient's heel while allowing for ease of use, patient comfort and less restricted mobility. This is particularly important for maintaining adequate blood flow to a patient's leg and foot, preventing the formation of pressure ulcers on the patient's heel and ensuring patient compliance. An ideal heel offloading apparatus would preferably be: 1) able to effectively offload pressure on a patient's heel, 2) inexpensive and 3) comfortable for the patient to wear.

### SUMMARY OF THE INVENTION

In one aspect, the prevent invention is directed to a heel offloading apparatus. The apparatus includes a cushion for supporting an intended wearer's ankle and a body for positioning the cushion relative to the ankle, wherein a density of the cushion is greater than a density of the body. The cushion is sized and adapted to surround a dorsal and adjoining lateral and medial sides of the Achilles tendon of an intended wearer. The cushion is further configured to elevate the ankle and heel of the intended wearer relative to the body of the apparatus when the intended wearer is wearing the heel offloading apparatus and lying in a supine position so as to relieve pressure from the heel.

In a second aspect, the invention is directed to a method for using a heel offloading apparatus. The heel offloading apparatus includes a cushion for supporting the ankle of the intended wearer and a body for positioning the cushion relative to the ankle, wherein the density of the cushion is greater than the density of the body. The method involves placing the intended wearer's ankle on the cushion such that the cushion surrounds a dorsal and adjoining lateral and medial sides of the Achilles tendon of the intended wearer and relieves pressure from the heel of the intended wearer by elevating the ankle and heel relative to the body of the apparatus when the intended wearer is wearing the apparatus and lying in a supine position.

### BRIEF DESCRIPTION OF THE DRAWINGS

FIG. 1 is a top view of a first embodiment of a heel offloading device in accordance with the present invention having a depressed portion in the support cushion.

FIG. 2 is a top view of a second embodiment of a heel offloading device in accordance with the present invention with a different support cushion.

FIG. 3 is a cross-sectional view taken along line A-A of FIG. 2.

FIG. 4 is a side view of the device of FIG. 3 showing a means for attaching the device to the foot of a wearer.

FIG. 5 is a cross-sectional view of an alternative embodiment of the device without a proximal opening 15.

FIG. 6 is a cross-sectional view taken at line B-B of FIG. 4.

### DESCRIPTION OF EMBODIMENTS OF THE PREFERRED EMBODIMENT(S)

For illustrative purposes, the principles of the present invention are described by referencing various exemplary embodiments. Although certain embodiments of the invention are specifically described herein, one of ordinary skill in the art will readily recognize that the same principles are equally applicable to, and can be employed in other systems and methods. Before explaining the disclosed embodiments of the present invention in detail, it is to be understood that the invention is not limited in its application to the details of any particular embodiment shown. Additionally, the terminology used herein is for the purpose of description and not of limitation. Furthermore, although certain methods are described with reference to steps that are presented herein in a certain order, in many instances, these steps may be performed in any order as may be appreciated by one skilled in the art; the novel method is therefore not limited to the particular arrangement of steps disclosed herein.

It must be noted that as used herein and in the appended claims, the singular forms “a”, “an”, and “the” include plural references unless the context clearly dictates otherwise. Furthermore, the terms “a” (or “an”), “one or more” and “at least one” can be used interchangeably herein. The terms “comprising”, “including”, “having” and “constructed from” can also be used interchangeably.

As used herein, “supine position” refers to an upwardly facing position wherein an individual is lying on their back and the dorsal region of their legs, such that the individual's foot and toes are facing upward, oriented substantially perpendicular to the dorsal region of the legs.

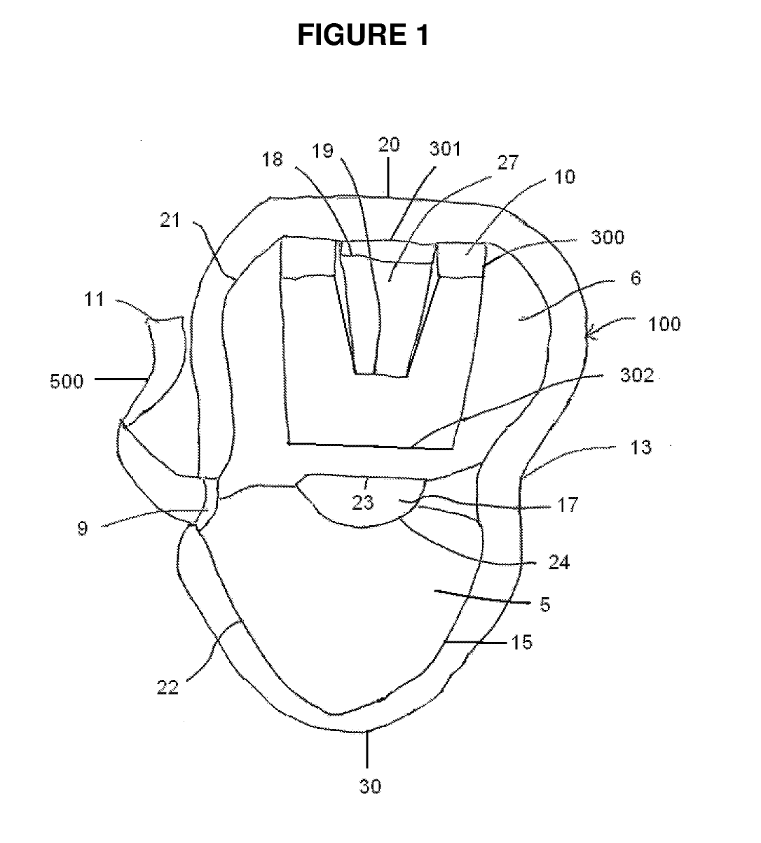

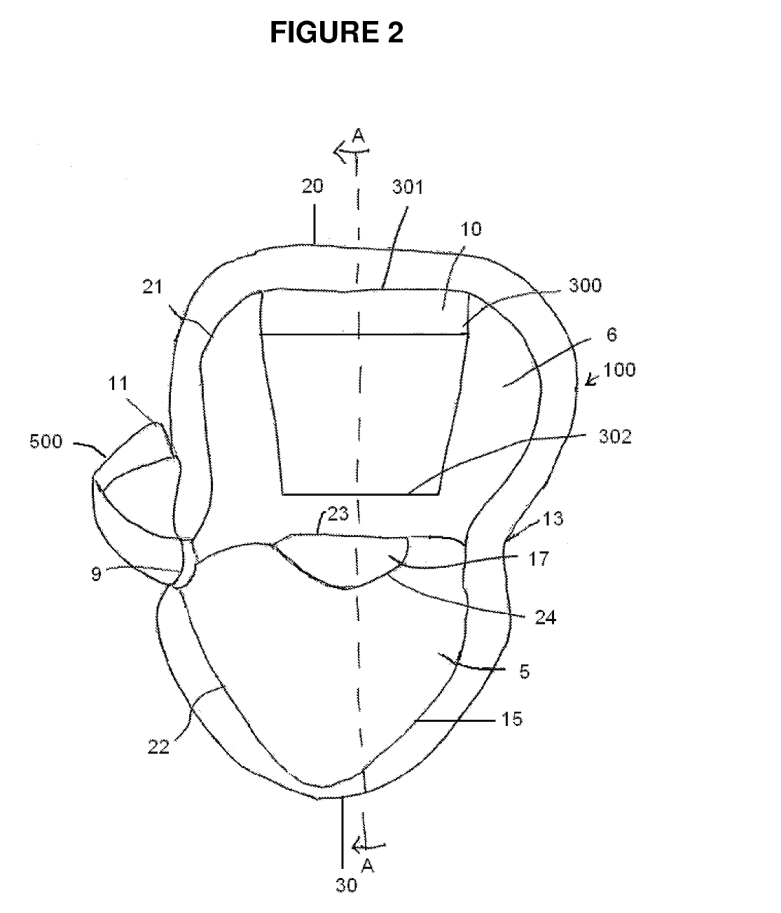

The present invention is directed to an improved heel offloading apparatus that is simple, effective for alleviating the pressure on a patient's heel and comfortable to use. As shown in the exemplary embodiment of FIG. 1-2, heel offloading apparatus includes a body 100 adapted for securing and positioning a support cushion 300 relative to a patient's ankle using a strap 500.

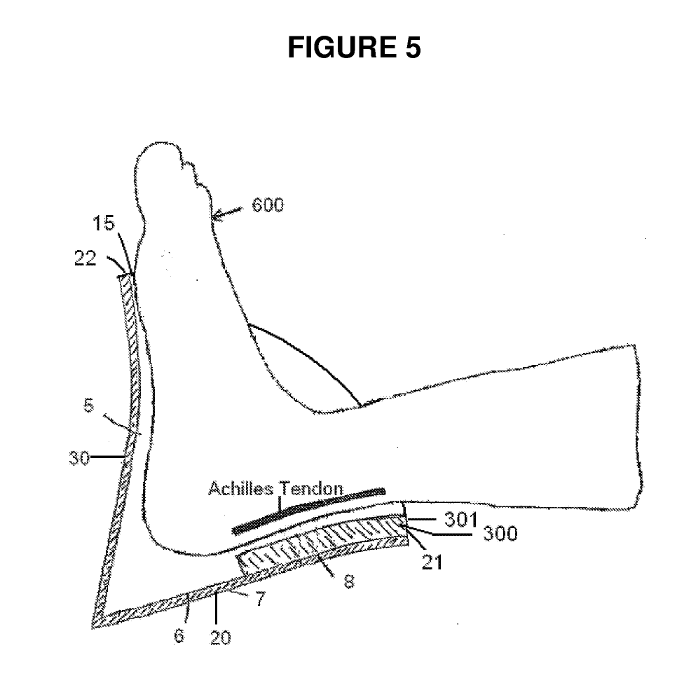

Body 100 may have any shape, dimension or configuration suitable for securing and positioning support cushion 300 relative to a patient's ankle. Preferably, body 100 may have a generally conical or pyramidal shape. In one embodiment, body 100 has a substantially enclosed cup like configuration for receiving a patient's heel including a proximal opening adapted for receiving and encircling a portion of a patient's foot and ankle, as shown in FIG. 5. In another embodiment, body 100 may have an open conical, pyramidal or elbow shaped configuration forming a correspondingly shaped channel including a proximal opening 15 connected to and spaced apart from a distal opening 17. Proximal opening 15 may be adapted for receiving a portion of a patient's foot and ankle while a smaller distal opening 17 may be positioned proximate to a patient's heel to permit ventilation.

As shown in FIG. 1, body 100 is defined by a first section 20 having an interior surface 6 adapted for surrounding a dorsal region and the sides of a patient's ankle and an adjoining second section 30 having an interior surface 5 adapted for surrounding a bottom region and the sides of a patient's foot 600. First and second sections 20, 30 function to secure and position support cushion 300 relative to a patient's ankle and are not intended brace, restrict the movement of, stabilize or provide substantial support to a patient's foot, ankle or leg. First section 20 may have the same or different dimensions than second section 30.

In one embodiment, first section 20 of the body 100 covers a lower surface of the foot proximate to the heel, preferably covering about ¼ to about ½ of the lower surface or sole of the foot, more preferably, covering about ¼ to about ⅓ of the lower surface of the foot. At most, first section 20 reaches up to the base of the toes, preferably, only up to a middle region of the lower surface of the foot. By virtue of not covering the toes, first section 20 facilitates ventilation and flexibility of the foot and ankle. Preferably, first section 20 and second section 30 are positioned to and constructed from a flexible material that enables the patient to maintain the full range of motion of the foot and lower leg, including the ankle. For example, when the heel offloading apparatus is mounted on and strapped to a patient, the foot and ankle is capable of dorsiflexion through an angle of about 0° to about 20°, plantar flexion through an angle of about 0° to about 50°, inversion through an angle of about 0° to about 35° and eversion through an angle of about 0° to about 15°.

Second section 30 of the body 100 covers the dorsal region and extends to cover at least a portion of the adjoining lateral and medial regions of the ankle, preferably at least the dorsal and the adjoining lateral and medial sides of the malleolus. In one embodiment, second section 30 extends up to about ⅓ of the height of the calf, preferably, up to about ¼ of the height of the calf, and more preferably, second section 30 does not extend up past the malleolus region of the ankle. This minimal coverage of the patient's lower leg increases patient comfort, ensures mobility and does interfere with treatment of other regions of the patient's leg.

In an exemplary embodiment, first and second sections 20, 30 form a body 100 having a volume of about 118.9 in³ to about 126.18 in³, preferably about 122.5 in³. When positioned on a patient, the heel offloading apparatus covers up to about ½ of the patient's foot, preferably, up to about ¼ of the patient's foot. The heel offloading apparatus also covers up to about ⅓ of the patient's calf including the ankle, preferably, up to about ¼ of the patient's calf including the ankle, and more preferably, up to about the malleolus region of the patient's ankle. When strapped to a patient, body 100 is loosely positioned relatively the patient's foot and lower leg, such that portions of the patient's foot and lower leg positioned within body 100 are spaced apart from the walls of body 100 to allow for ventilation and to ensure the patient maintains full mobility of the foot and lower leg, including the ankle, while fixedly securing support cushion 300 relative to the patient's ankle.

A proximal edge 21 of first section 20 is connected to a proximal edge 22 of second section 30 to form proximal opening 15. Preferably, proximal opening 15 has a longest dimension of about 9.2 inches to about 11 inches, preferably about 9.5 inches to 10.5 inches. In embodiments wherein body 100 has a cup like configuration, first section 20 and second section 30 are connected so as to form a continuous, substantially enclosed support structure. In embodiments wherein body 100 has a channel like configuration, distal opening 17 may be located anywhere within first or second section 20, 30. Preferably distal opening 17 is located proximal to a patient's heel such that a distal edge 23 of first section 20 is connected to a distal edge 24 of second section 30, forming distal opening 17. Distal opening 17 may have a longest dimension of about 3.34 inches to about 3.68 inches, preferably about 3.5 inches. Optionally, first and second sections 20, 30 may further include a plurality of openings therein, not shown, to provide further ventilation.

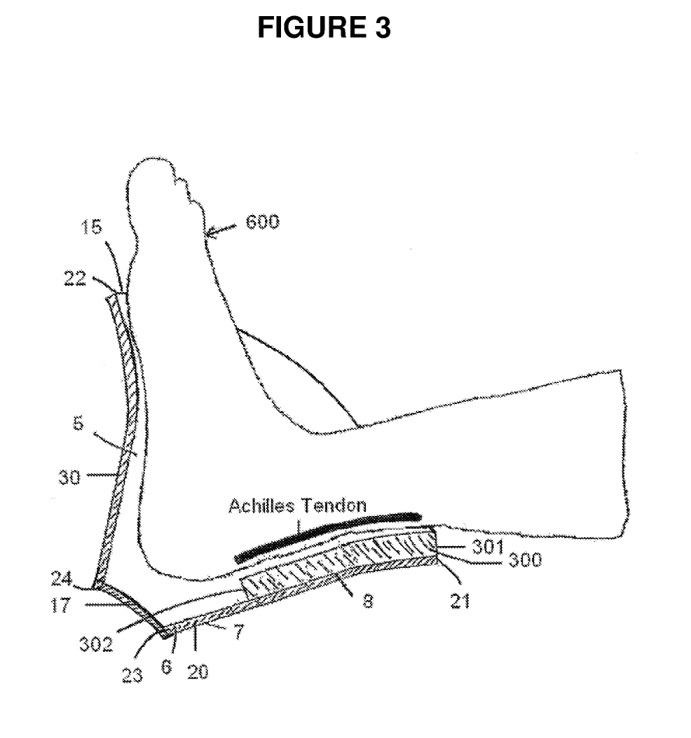

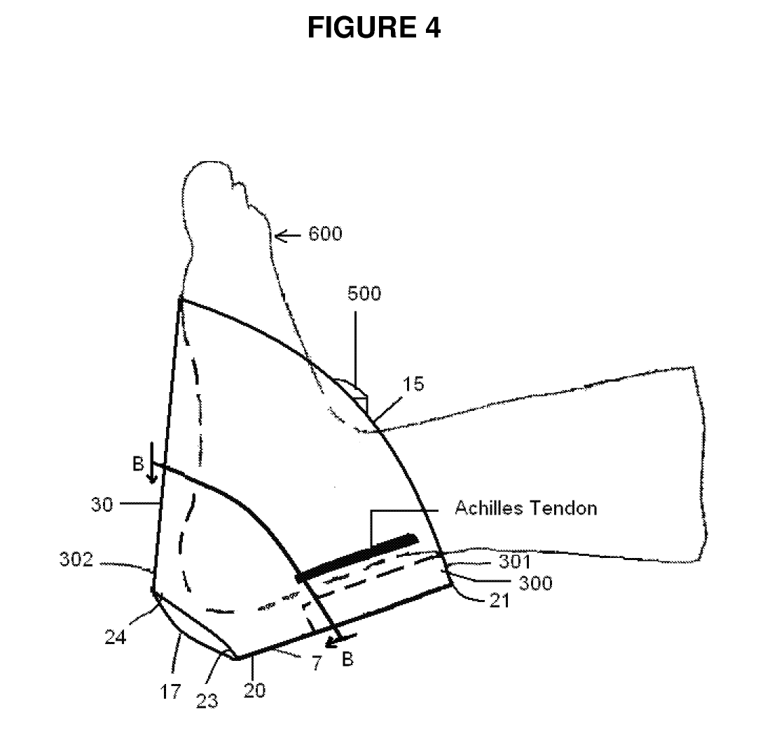

In the exemplary embodiment of FIGS. 3-4 body 100 wraps about and is positioned proximate to a patient's ankle and central region of a patient's foot, forming a relatively unrestrictive heel offloading apparatus having a light weight and compact configuration that allows a patient to retain mobility and the full range motion of the foot, ankle and leg.

Body 100 may be constructed from any soft, flexible material. Exemplary materials may include plush material, polymer bead filled cushions such as styrofoam bead filled pillows, gel filled cushions, fabrics and/or a resilient material, such as a foam material like memory foam. In one embodiment, body 100 is constructed from a foam material having a lower density than a foam material used to construct support cushion 300, whereby body 100 is sufficiently flexible to wrap around the patient's ankle and foot while support cushion 300 is able to support and withstand the pressure applied by the patient's lower leg and foot. In an exemplary embodiment, body 100 is constructed from a foam material having a density of about 0.0158 to about 0.017 ounces per in³, preferably, about 0.0158 to about 0.0168 ounces per in³. The foam material may further have any suitable configuration for fixedly securing a patient's foot within the heel offloading apparatus. Exemplary foam configurations include a substantially flat, curved or egg crate configuration, wherein an interior surface of body 100 for supporting a patient's foot and ankle has a substantially flat, curved or egg carton configuration.

Positioned on an interior surface of body 100 is a support cushion 300 that prevents a patient's heel from contacting an interior surface of body 100 or any support surface on which body 100 is positioned, such as a bed. Support cushion 300 is able to successfully offload pressure to a patient's heel by elevating, supporting and stabilizing the patient's ankle, specifically the Achilles tendon, above the surface of body 100 substantially by itself with no or only minimal assistance from the body 100. In addition to elevating a patient's ankle, support cushion 300 is configured to securely retain and fixedly orient a patient's ankle within body 100 of the heel offloading apparatus of the present invention.

Support cushion 300 therefore may have any size, shape and configuration capable of supporting a patient's ankle and elevating the patient's heel when the patient is lying in a supine position. Preferably, support cushion 300 is suitably sized and shaped to prevent a patient's ankle from rolling off of or otherwise being separated from support cushion 300. In an exemplary embodiment, support cushion 300 is sized to at least surround the dorsal side of the Achilles tendon and surround at least portions of adjoining medial and lateral sides of the Achilles tendon so as to substantially independently support and stabilize the ankle, wherein the cushion elevates the ankle and heel of the intended wearer relative to the body to relieve pressure from the intended wearer's heel, when the intended wearer is wearing the heel offloading apparatus and lying in a supine position. Preferably, support cushion 300 directly contacts and covers at least a dorsal region of the ankle and extends to adjoining lateral and medial regions of the ankle, covering about 50% or more, preferably, about 60% or more, more preferably, about 70% or more, and most preferably, about 80% or more of the ankle, thereby fixedly securing and orienting the ankle within support cushion 300 and body 100. The support cushion 300 may contact and cover about 50% to about 85%, preferably, about 60% to about 85% and more preferably, about 75% to about 85% of the ankle, while ensuring that at least a dorsal region of the ankle is covered and that the coverage extends to adjoining lateral and medial regions of the ankle. While directly contacting and supporting the ankle up to the malleolus region, the lower region of support cushion 300 is spaced apart from and neither contacts nor covers any portion of the calcaneus to ensure the patient maintains full mobility of the ankle. In the exemplary embodiment shown in FIG. 2, support cushion 300 has a rectangular configuration with a length of about 4.75 inches and a width of about 3.75 inches. These dimensions may optionally vary up to about 3%. The upper surface area of support cushion 300 is adapted for contacting and supporting the ankle and preferably has an area of about 12 in² to about 25 in², more preferably, about 12 in² to about 20 in², and most preferably, about 16 in² to about 20 in². Preferably, edges or corners of the support cushion 300 can be rounded to provide greater patient comfort. Additionally, support cushion 300 and body 100 preferably each has a thickness of about 1 in. to 3 in., more preferably, about 1 in. to about 1½ in prior to receiving a patient's foot and ankle. Preferably, body 100 may be about ¼ inch to 2 inches thick, more preferably about 1 inch thick prior to loading. In an exemplary embodiment, support cushion 300 is positioned so as to only support a patient's ankle. For patients with wounds located on an upper region of their calf and leg, support cushion 300 and body 100 is restricted to a lower region of the leg, thereby avoiding direct contact with the wound and preventing interference with a prescribed wound treatment. In an alternative embodiment, support cushion 300 may be positioned so as to extend from the beginning of a patient's ankle to a mid calf region.

Support cushion 300 may be integrally formed as part of body 100. Alternatively, support cushion 300 may be removably attached to body 100 using any removable fastener, such as hook and loop fasteners or adhesives, to adjustably position the location of the support cushion 300 and customize the heel offloading heel boot. For example, a portion of an exterior surface 8 of support cushion 300 may be covered with hooks, enabling support cushion 300 to be removably attached to a portion of an interior surface 6 of first section 20 covered with corresponding mating loops. In one embodiment, two or more support cushions 300 may be stacked on top of one another to achieve a desired elevation of a patient's ankle to comfortably and effectively offload the heel. By way of example, hook and loop fasteners may be located on opposing surfaces of two or more support cushions 300 to enable vertical stacking of the support cushions 300.

Preferably, a proximal edge 10 of support cushion 300 contacts and is approximately aligned with a proximal edges 21, 22 of body 100. Alternatively, support cushion 300 may be displaced by about ¼ inch relative to proximal edges 21, 22. The length of support cushion 300 may also be substantially co-extensive with the length of first section 20 or it may be shorter, if desired. In the embodiment shown in FIG. 1, a proximal end 301 of support cushion 300 is aligned with the proximal end 21 of first section 20 while a distal end 302 of support cushion 300 extends approximately three quarters of the way from proximal edge 21 to distal edge 23 of first section 20. Support cushion 300 is preferably spaced apart from the distal edge 23 of first section 20 and distal opening 17 by about 1.7 inches to prevent support cushion 300 from contacting the calcaneus.

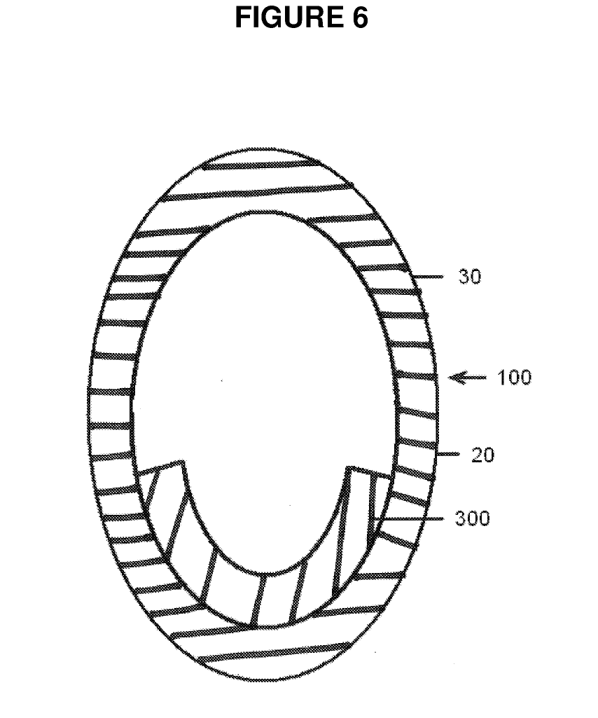

Preferably, the ratio of the upper surface area of support cushion 300 adapted for contacting and supporting the ankle to the inner surface area of body 100 for receiving the patient's foot and lower leg is about ¼ or greater, more preferably, about ⅓ to or greater and most preferably, about ½ or greater. In one embodiment, the ratio of the upper surface area of the support cushion 300 to the inner surface area of body 100 is about 1:4 to about 1:2, more preferably, about 1:4 to about 1:3. As viewed in a cross-section of the heel offloading apparatus in the direction shown in FIG. 6, the support cushion 300 preferably extends around about ⅓ or more of an inner surface of first section 20, more preferably, about ½ or more of first section 20. This length will vary dependent upon the location of the cross-sectional view since the inner surface of first section 20 will become longer as the cross-section is moved towards the proximal opening 15. In one embodiment, support cushion 300 has a length of about ¼ to about ½, preferably, about ⅓ to about ½ of the length of first section 20.

As shown in the exemplary embodiment of FIG. 1, support cushion 300 can have a depressed portion 27 proximate to proximal end 301 to accommodate and support portions of the adjoining lateral and medial sides of the Achilles tendon. Depressed portion 27 functions to relieve some of the pressure on the Achilles tendon and more evenly distribute the pressure along a patient's ankle. Preferably, depressed portion 27 is positioned in a proximal portion 10 of the support cushion 300 and may have a tapered configuration as shown in FIG. 1, wherein the depth of the depression is greatest at a proximal edge 18 and gradually decreases until it reaches a distal edge 19 of depressed portion 27 that is proximal to a central portion (as shown in FIG. 1) or, alternatively, to a distal end of the support cushion 300. In an exemplary embodiment, depressed portion 27 conforms to the shape of a portion of the intended wearer's ankle surrounding the Achilles tendon and may be angled at its proximal and distal ends. In an exemplary embodiment, depressed portion 27 may have a density of about 0.015 ounces per in³ to about 0.02 ounces per in³, preferably, about 0.0172 ounces per in³ to about 0.0182 ounces per in³.

Support cushion 300 may be constructed from any soft, resilient, flexible material for supporting a patient's ankle, including a plush material, a polymer bead filled cushion such as a styrofoam bead filled pillow, a gel filled cushion, fabrics or foam material, such as memory foam. In an exemplary embodiment, support cushion 300 may be constructed from a foam material having a substantially uniform and continuous planar inner surface for supporting a patient's ankle. In order to provide sufficient support for the ankle, the foam material for both body 100 and support cushion 300 needs to be of a density and rigidity such that they are capable of fixedly orienting a patient's ankle and foot within the heel offloading apparatus, thereby preventing the undesirable sliding, twisting and reorienting of a patient's foot within the heel offloading apparatus. In an exemplary embodiment, the density of the foam used to construct support cushion 300 is about 0.0135 to about 0.0231 ounces per in³, preferably about 0.015 to about 0.0231 ounces per in³, more preferably 0.0135 to about 0.165 ounces per in³ or about 0.0218 to about 0.0231 ounces per in³, and the combined density of body 100 and support cushion 300 may be about 0.0144 to about 0.0179 ounces per in³, preferably about 0.0144 to about 0.0176 ounces per in³. In another embodiment, the combined density may be about 0.016 to about 0.0179 ounces per in³, preferably, about 0.169 to about 0.0179 ounces per in³. Support cushion 300 is preferably firmer and/or denser than body 100 enabling the support cushion 300 to substantially independently support, stabilize and elevate the ankle.

Preferably, the ratio of the density of support cushion 300 to the density of body 100 is about 1.25 or more, more preferably, about 1.4 or more, most preferably, about 1.5 or more. In one embodiment, the ratio of the density of body 100 to the density of support cushion 300 is about 1.25 to about 3, more preferably, about 1.25 to about 2, and most preferably, about 1.25 to about 1.5. The thickness of the foam used to construct body 100 and support cushion 300 may be adjusted as necessary to further secure or elevate a patient's ankle and heel to a desired height. Preferably, the height of support cushion 300 preferably should not raise the leg to an uncomfortable position or hyperextends the knee.

Optionally, a protective covering may be fitted over the heel offloading apparatus, wherein the covering surrounds body 100 and/or support cushion 300. The covering is preferably made of a material having a low coefficient of friction to facilitate movement of the exterior surface of body 100 relative to a patient's bed linens and clothing, thereby preventing the heel offloading apparatus from being caught in a patient's bedding or clothing. Exemplary materials used to fabricate the covering include polyester, rayon, nylon and cotton.

Heel offloading apparatus further includes one or more straps 500 to secure the body 100 to a patient's foot, ankle, lower leg or combination thereof. Straps 500 are preferably constructed from a soft material, such as fabric, that do not irritate the patient's skin Strap 500 includes a first end 9 that may be attached to any interior surface 5 or exterior surface 7 of body 100. Preferably, first end 9 is affixed to a surface proximate to the proximal edge 21, 22 of first or second sections 20, 30. First end 9 can be removably attached to a surface of body 100 using any conventional removable fastener, such as hook and loop fasteners, snaps, buttons, string and grommets or combinations thereof. Alternatively, first end 9 may be integrally formed with or otherwise permanently affixed to body 100, such as by stitching or by applying an adhesive.

A second end 11 of strap 500 may be attached to body 100 at a location opposite where first end 9 is attached to body 100 in order to secure body 100 to the patient's foot. Preferably first end 9 is located proximate to a perimeter of proximal opening 15 between first and second sections 20, 30 while second end 11 is located proximate to the perimeter of proximal opening 15 on an opposite side of body 100, such that strap 500 is positioned over a patient's ankle. Second end 11 of the strap 500 may be removably attached to the opposite side 13 of body 100 using any conventional fastener, including hook and loop fasteners, snaps, buttons, grommets or combinations thereof. Two or more or a plurality of straps may be positioned on a surface of body 100 to further secure body 100 to a patient's foot 600, as in shown in FIG. 4. One advantage of the present invention results from the fact that strap 500 secures body 100 to foot 600 at a location at or below the ankle. When strapped to a patient, strap 500 is positioned relative to body 100 and proximal opening 15 so as to span the malleolus region of the ankle. Preferably, strap 500 is positioned so as to be located across the lateral and medial malleolus. In one embodiment, strap 500 is positioned at a mid section of body 100 and proximal opening 15. Thus positioned, only one strap is necessary to secure the heel offloading apparatus to a patient facilitate attachment and removal of the apparatus. Furthermore, the use of only a single strap provides the wearer with a greater range of motion of foot 600 and ankle while wearing the device, increasing comfort, allowing exercise to decrease potential complications and potentially improving patient compliance.

The present invention may be used for a wide variety of applications. In particular, it is an effective heel offloading support that may be worn by immobile patients or patients at risk of developing heel pressure ulcers due to extended periods of immobility. It is envisioned that the heel offloading apparatus of the present invention can also be used in operation rooms as a heel offloading device for long surgeries. The present invention provides a number of advantages in comparison to conventional boots and foot support apparatuses. Specifically, the heel offloading apparatus of the present application is disposable, comparatively inexpensive to manufacture, effective in completely floating the heel, and comfortable for patients as it allows for adequate blood flow and is small in size, making it convenient to use.

The present invention is aimed at providing an inexpensive, simple, flexible, convenient, and effective way to completely offload the heel, while still allowing adequate blood flow and freedom of movement at the leg and heel. Furthermore, the invention is designed to securely retain and fixedly orient a patient's ankle and foot within the heel offloading apparatus so as to prevent sliding, twisting and reorientation of the heel within the heel offloading apparatus. The heel offloading apparatus is also easily attached to and removed from a patient's foot due to the simplicity of the design and provides ventilation to the entire heel. It is envisioned that the heel offloading apparatus may be sized to fit any individual since this aspect of the device is easily modified by replacing or adding additional foam or other material. The device may be used for a brief period of one or two days or may be used for longer durations as necessary.

It is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

### EXAMPLE

In an exemplary embodiment, the heel offloading apparatus has an open conical configuration forming a conical channel for receiving a patient's ankle, as shown in FIG. 2. The heel offloading apparatus has a proximal opening 15 with a longest dimension of about 9.5 inches for receiving a patient's foot and ankle and a distal opening 17 having a longest dimension of about 3.5 inches located proximate to the patient's heel. The body 100 of the heel offloading apparatus is constructed from a 1 inch thick foam material, wherein the inner surface of body 100 that receives a patient's foot and ankle has a substantially flat configuration. A rectangular foam support cushion 300 adapted for receiving, supporting and contacting only a patient's ankle is integrally formed with body 100 so as to be positioned adjacent to an edge of proximal opening 15 and spaced apart from distal opening 17. Support cushion 300 is configured to contact and support only the patient's ankle and has a length of about 4.75 inches, a width of about 3.75 inches and a thickness of about 1 inch. The density of support cushion 300 is about 0.016 ounces per in³, and the combined density of support cushion 300 and body 100 is about 0.0174 ounces per in³. Additionally, the density of support cushion 300 is greater than the density of body 100. A protective polyester covering is fitted over the exterior and interior surfaces of the heel offloading apparatus, covering body 100 and support cushion 300, to prevent the heel offloading apparatus from getting caught in the patient's bedding and clothing. A hook and loop strap 500 is attached to body 100 adjacent to an edge of proximal opening 15 securing the heel offloading apparatus to the patient.

What is claimed is:

1. A heel offloading apparatus comprising:
a cushion for supporting an intended wearer's ankle; and
a body for positioning the cushion relative to the ankle,
wherein the cushion is sized and adapted to surround a dorsal side and at least portions of adjoining lateral and medial sides of an Achilles tendon of the intended wearer, wherein a density of the cushion is greater than a density of the body, and wherein the cushion elevates the ankle and heel of the intended wearer relative to the body when the intended wearer is wearing the heel offloading apparatus and lying in a supine position.

2. The apparatus of claim 1, wherein the ratio of the density of the cushion to the density of the body is about 1.25 or more.

3. The apparatus of claim 1, wherein the ratio of the density of the cushion to the density of the body is from about 1.25 to about 3.

4. The apparatus of claim 1, wherein the cushion has a density of from about 0.015 ounces per in³ to about 0.0231 ounces per in³.

5. The apparatus of claim 4, wherein the cushion and the body have a combined density of from about 0.016 ounces per in³ to about 0.0179 ounces per in³.

6. The apparatus of claim 1, wherein the cushion is sized such that, when worn by the intended wearer, the cushion surrounds lateral and medial sides of the malleolus.

7. The apparatus of claim 6, wherein the cushion is sized to cover about 50% or more of the ankle when the intended wearer is wearing the heel offloading apparatus.

8. The apparatus of claim 1, wherein the apparatus permits full range of motion of the foot of the intended wearer when the apparatus is worn by the intended wearer.

9. The apparatus of claim 8, wherein the body comprises:
a first section surrounding a portion of the ankle of the intended wearer; and a second section adjoining the first section, wherein the second section surrounds a portion of a foot of the intended wearer when the apparatus is worn by the intended wearer, and the first section of the body is sized to cover less than about ⅓ of the lower calf and wherein the second section of the body is sized to cover about ¼ to about ½ of the lower surface of the foot.

10. The apparatus of claim 1, wherein a ratio of an upper surface area of the support cushion adapted for contacting and supporting the ankle of the intended wearer when the apparatus is worn by the intended wearer to an inner surface area of the body for receiving the foot and lower leg when the apparatus is worn by the intended wearer is about ¼ or greater.

11. The apparatus of claim 1, wherein the cushion has a thickness in an unloaded condition of about 1 inch to about 3 inches.

12. The apparatus of claim 1, wherein the cushion is constructed from a material or structure selected from the group consisting of: foam, fabric, a polymer bead filled cushion and a gel filled cushion.

13. The apparatus of claim 1, wherein the cushion comprises a depression having a shape that conforms to and is adapted for receiving and supporting a portion of the intended wearer's ankle surround the Achilles tendon.

14. The apparatus of claim 13, wherein the depression has a proximal edge proximate to a proximal edge of the body and an opposing distal edge, wherein the depression has a tapered configuration such that the depth of the depression is greatest at the proximal edge and gradually decreases toward the distal edge.

15. The apparatus of claim 1, further comprising a strap capable of connecting opposing sides of the body, wherein the strap is adapted to be attached to corresponding middle regions of the body such that when worn by an intended wearer, the strap secures the body to an intended wearer across a lateral and medial malleolus.

16. The apparatus of claim 1, further comprising a covering surrounding the body and cushion.

17. A method for using a heel offloading apparatus, said heel offloading apparatus comprising:
a cushion for supporting the intended wearer's ankle; and
a body for positioning the cushion relative to the ankle, wherein a density of the cushion is greater than a density of the body;
placing the intended wearer's ankle on the cushion such that the cushion surrounds a dorsal side and adjoining lateral and medial sides of an Achilles tendon of the intended wearer and relieves pressure from a heel of the intended wearer by elevating the ankle and the heel relative to the body of the apparatus when the intended wearer is wearing the apparatus and lying in a supine position.

18. The method of claim 17, further comprising the step of positioning a strap of the apparatus across a lateral and medial malleolus of the intended wearer so as to connect opposing sides of the body and secure the heel offloading apparatus to an intended wearer.

19. The method of claim 17, wherein the cushion further comprises a depression formed therein and the placing step places a portion of the ankle surrounding the Achilles tendon in the depression.

20. The method of claim 18, wherein the positioning step fixedly positions the cushion relative to the ankle of the intended wearer while permitting full range of motion of the foot and ankle.
